(19) United States
(12) Patent Application Publication
(10) Pub. No.: US 2025/0021286 A1
(43) Pub. Date: Jan. 16, 2025

(54) Method and Apparatus for Operating Data Glasses in a Vehicle

(71) Applicant: Bayerische Motoren Werke Aktiengesellschaft, Muenchen (DE)

(72) Inventors: Tobias BAUERNFEIND, Muenchen (DE); Wolfgang HABERL, Muenchen (DE); Alan KEIM, Muenchen (DE); Manfred PAULI, Bruckberg (DE)

(21) Appl. No.: 18/732,014

(22) Filed: Jun. 3, 2024

(30) Foreign Application Priority Data
Jul. 13, 2023 (DE) 10 2023 118 551.9

(51) Int. Cl. G06F 3/14; G06F 3/01; G06V 20/59; G06V 40/20

(52) U.S. Cl. CPC G06F 3/14; G06F 3/017; G06V 20/59; G06V 40/20

(57) ABSTRACT

A display system is operated with an assistance system tied to the vehicle and data glasses in a vehicle. It is monitored whether a presentation surface has been brought from a stowed position into a position of use in which the presentation surface faces the data glasses. The presentation surface is a dark or black unstructured surface. If it is recognized that the presentation surface has been brought into the position of use, start information from the assistance system is transmitted to the data glasses. Media information in the data glasses is automatically started and displayed depending on the start information.

### CROSS REFERENCE TO RELATED APPLICATION

This application claims priority under 35 U.S.C. § 119 from German Patent Application No. DE 10 2023 118 551.9, filed Jul. 13, 2023, the entire disclosure of which is herein expressly incorporated by reference.

### BACKGROUND AND SUMMARY

The invention relates to the use of augmented reality data glasses in vehicles, and in particular for facilitating the presentation of image or video information.

The invention relates to augmented reality (AR) data glasses, and in particular to methods for operating AR data glasses for presenting media content in a virtual presentation window.

Augmented reality data glasses, also called head-mounted displays, which are able to depict an image on one or two display surfaces in the field of view of the wearer of the data glasses using a display apparatus, are known. The display surfaces may correspond to reflection surfaces that direct images into the eye of the wearer of the data glasses. The viewing openings in the data glasses are transparent, such that it is also possible to perceive the real environment in the usual way through the display surfaces of the data glasses. The display surfaces are arranged in the viewing openings such that information to be displayed, such as text, symbols, graphics, video displays and the like, can be displayed in a manner superimposed on the perception of the environment.

The information can be presented in a contact-analog manner to the wearer of the data glasses, i.e. presented in such a way that the information, as display objects, is superimposed on or oriented to a specific assigned environment object or a specific position or a specific local area in the real environment, or that the display object to be displayed is displayed in a specific alignment/orientation of the data glasses or the viewing direction of their wearer.

However, in order to display the display object correspondingly in a contact-analog manner on the display surfaces of the data glasses, it is necessary to know the position of the environment object in the reference environment and the viewing direction of the user. The user's viewing direction when wearing the data glasses is assigned fixedly to their head pose or glasses pose, i.e. the 3D position and the 3D orientation of the data glasses corresponding to six degrees of freedom (6 DoF).

The glasses pose can be determined by an external pose detection unit (outside-in tracking method), in which an interior camera of the vehicle captures the interior, including the head of the wearer of the data glasses, and either the pose of the head is determined by evaluating the camera image using vision tracking methods and the glasses pose is derived therefrom or the glasses pose is directly determined by recognizing the shape of the glasses. In these so-called outside-in tracking systems, a glasses pose tied to the vehicle is determined, i.e. a glasses pose based on a vehicle coordinate system tied to the vehicle.

The display of media information, such as image or video information, in data glasses requires a dark viewing background, since dark or black pixels of an image to be presented are presented transparently in data glasses. The transparent presentation of black pixels enables the augmented perception of environment objects while simultaneously superimposing display objects in the data glasses.

When viewing image or video information in the data glasses with dark image areas, this may be disadvantageous, especially if the viewing background is bright and/or not uniform or structured. For viewing image or video information, the wearer of the data glasses must therefore search for a dark background surface and keep looking at the dark background while viewing the image or video information, such that the image or video information can be viewed without disturbance.

An object of the present invention is to provide a convenient possible way of viewing image or video information in the data glasses.

This object is achieved, inter alia, by the method for operating a display system with data glasses in a motor vehicle according to claim 1 and by the display system according to the coordinate claim.

Further embodiments are specified, inter alia, in the dependent claims.

According to a first aspect, a method for operating a display system with an assistance system tied to the vehicle and data glasses in a vehicle is provided, having the following steps:
monitoring whether a presentation surface has been brought from a stowed position into a position of use in which the presentation surface faces the data glasses, wherein the presentation surface is a dark or black, in particular unstructured surface;
if it is recognized that the presentation surface has been brought into the position of use, transmitting start information from the assistance system to the data glasses;
automatically starting and displaying media information in the data glasses depending on the start information.

In addition, the following steps may be provided:
monitoring whether the presentation surface has been brought from the position of use into a stowed position in which the presentation surface is stowed;
if it is recognized that the presentation surface has been brought into the stowed, transmitting stop information from the assistance system to the data glasses;
automatically stopping the display of the media information in the data glasses depending on the stop information.

As described at the outset, a wearer of data glasses needs a dark unstructured background surface to view image or video information, which background surface is only present in a few areas in the vehicle. In particular, there may be apparatuses in the vehicle which can be folded out or brought into a position of use in any other way in order to provide a dark background surface in a comfortable viewing direction. Appropriately operating the data glasses now makes it possible to present image or video information that can be viewed by the user by directing their gaze to the dark background surface. Thus, for example, the presentation surface may be a rear side of the sun visor, such that it is brought into a position of use by folding it down, and the user can start the presentation of the image or video information through the data glasses and can direct their gaze to the corresponding display surface of the sun visor.

It may be provided that the process of monitoring whether the presentation surface has been brought into the position of use or into the stowed position is carried out by evaluating a camera image from an interior camera with gesture recognition, wherein the position of use or the stowed position is adopted by recognizing a particular hand gesture in each case.

The above method provides for the interior camera provided for the tracking of the glasses pose of the data glasses or other vehicle applications, such as fatigue detection, to be used to monitor operating actions of the user. This can be effected, for example, using conventional gesture recognition methods. If it is recognized by the interior camera and the corresponding evaluation that a presentation surface is brought into a position of use, such as by folding down the sun visor or folding out or otherwise manually moving a corresponding element on the instrument panel, corresponding information can be transmitted to the data glasses. This information can cause image or video information to be presented automatically in the data glasses, with the result that the user does not have to interact any further for the purpose of triggering or starting functions in the data glasses.

Furthermore, if it is recognized that the presentation surface has been brought into the position of use, in addition to the start information, the media information to be presented is also transmitted from the assistance system to the data glasses.

For example, the presentation surface may be located on a rear side of a foldable sun visor.

It may be provided that the media information is displayed in a contact-analog manner with respect to a coordinate system tied to the vehicle above the presentation surface.

Embodiments are explained in more detail below with reference to the accompanying drawings.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a schematic representation of a display system in a vehicle;

FIG. 2 shows a schematic representation of the display system; and

FIG. 3 shows a flowchart for illustrating the method for operating the display system.

### DETAILED DESCRIPTION OF THE DRAWINGS

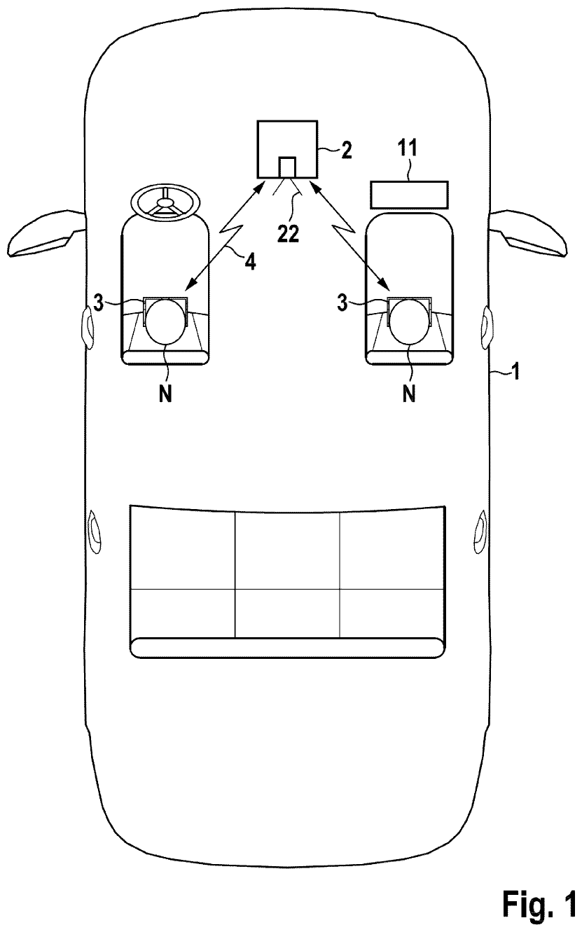

FIG. 1 schematically shows a plan view of a display system with a vehicle 1, in which a vehicle occupant N wears data glasses 3. The data glasses 3 are connected to an assistance system 2 tied to the vehicle via a communication connection 4. The communication connection 4 is designed as a data transmission channel, for example in the form of a wireless or a wired communication connection. The communication connection 4 is capable of transmitting any kind of data and information between the assistance system 2 and the data glasses 3, for example based on a packet-bound data transmission. For example, the communication connection 4 may be based on Wi-Fi, Bluetooth, Bluetooth Low Energy, or a comparable standardized radio protocol.

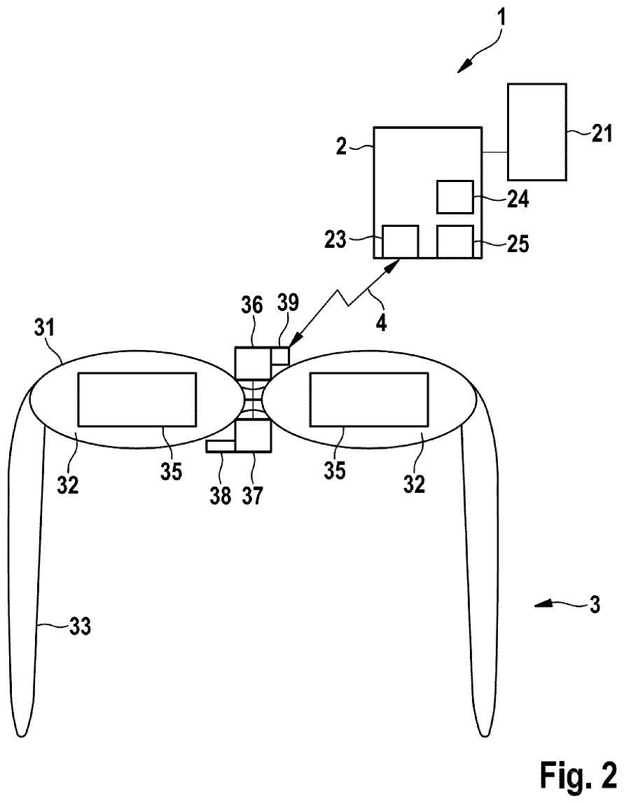

FIG. 2 shows a schematic representation of the display system.

The assistance system 2 may be provided in particular in a stationary form in the vehicle 1. The assistance system 2 may be equipped with a communication unit 23 that enables the data to be transmitted between the data glasses 3 and the assistance system 2 via the communication connection 4.

An interior camera 21 is used to continuously capture the interior of the vehicle in order to provide a camera image of a vehicle interior. The interior camera 21 may comprise, for example, an RGB camera, an IR camera, a fisheye camera, a dynamic vision sensor and the like.

The assistance system 2 may have a control unit 24 to evaluate the camera image using a pattern recognition method or a vision tracking method and to determine therefrom an absolute glasses pose indication of the one or more data glasses 3 in the vehicle. The glasses pose indication represents an absolute glasses pose relative to a vehicle coordinate system.

The absolute glasses pose indication can be used by means of sensor data fusion methods to perform the glasses pose indication in the data glasses for a contact-analog display of display objects.

The control unit 24 can further evaluate the camera image using vision tracking methods and can recognize and identify hand gestures of the users. In particular, the control unit 24 may be designed to recognize a gesture that is used by a user to bring a presentation surface for viewing image or video information from a stowed position into a position of use in which the presentation surface is clearly and comfortably visible, or from a position of use into a stowed position in which the presentation surface is stowed and preferably not visible by the user.

A possible presentation surface may be provided on a rear side (the surface facing the user in the position of use) of a sun visor 11. The presentation surface is dark or black and preferably has no visible structuring.

Furthermore, the assistance system 2 comprises a vehicle motion sensor system (IMU sensor system) 25, which may be designed for example in the form of a 6-DoF inertial sensor. This provides movement indications in relation to a movement of the vehicle 1 in the form of translational accelerations or angular accelerations or angular speeds.

The data glasses 3 comprise two transparent lenses 32 that are enclosed in a frame 31 in a manner known per se. The frame 31 is provided, by way of example, with glasses temples 33, so that the data glasses 3 are able to be worn on the head of a user.

One or both lenses 32 (glasses lenses) are furthermore provided with a transparent display surface 35, through which a display image for depicting virtual display objects is able to be projected in the eye of the wearer of the data glasses 3 by a suitable device, such as for example a display device 36 arranged on the frame 31. The display device 36 may have a microprocessor or a comparable computing unit and a display unit, such as for example a projection device or the like. The display unit may be designed to direct the electronically generated display image onto the display surface 35 and to image/depict it there.

Due to the transparent design of the display surface 35, the electronically generated image is able to overlay the real environment able to be perceived through the display surface 35. The display device 36 may be used to present a virtual display object, such as for example text, a symbol, media content, such as image information or video information, a graphic or the like, on one or both display surfaces 35.

The data glasses 3 may be worn on the head of the user like a typical visual aid, wherein the data glasses 3 may rest on the nose of the user by way of the frame 31 and the temples 33 may lie laterally against the head of the user. The viewing direction of the user straight ahead is then effected through the transparent display surfaces 35 of the lenses 32, such that the viewing direction and position of the user, specified by an eye position and an optical visual axis (eye axis), have a fixed reference with respect to the position and orientation of the data glasses 3, i.e. the glasses pose.

For the display of display objects, corresponding object information in the form of object data is transmitted from the assistance system 2 to the data glasses 3 or already provided in the data glasses 3. The object data in this case indicate the type of display object, such as for example a text object, an icon or another identifier of a display area, the viewing angle area or the viewing angle areas in which the display object should be displayed on the display surface 35 and the object position in the environment of the data glasses 3. The object position may be indicated with respect to an environment coordinate system tied to the world or a vehicle coordinate system tied to the vehicle.

Provision may be made for a glasses motion sensor system 38 (IMU sensor system, inertial sensor system) that is designed for example in the form of a 6-DoF inertial sensor. This provides relative or differential glasses movement information in relation to a movement of the data glasses 3 in the form of translational accelerations and angular accelerations or angular speeds, which may be converted, in particular by a respective (including double) integration, into a change in position and orientation, that is to say a differential glasses pose, such that it is possible to update an indication in relation to an absolute glasses pose at high frequency by applying a time integration method. The absolute glasses pose indication determined by means of the interior camera can be used for sensor data fusion in the data glasses in order to compensate for integration errors in the absolute glasses pose determined in the data glasses on the basis of the differential glasses poses.

The relative or differential glasses movement information in the form of changes in position and orientation determined via the glasses motion sensor system 38 can be used, in a manner known per se, to determine a glasses pose indication, tied to the world, for a current glasses pose of the data glasses 3. In order to determine an absolute glasses pose indication tied to the vehicle, the glasses movement information must be adjusted depending on the vehicle movement information (also relative or differential), such that only the movement of the data glasses 3 in the vehicle can be evaluated. The difference in movement between the movement of the data glasses and the movement of the vehicle is determined and evaluated for the purpose of determining the glasses pose.

Using a control unit 37, it is possible to receive e.g. object information via a communication device 39 from the assistance system 2 or provide and process the object information in some other way, such that it is displayed in a contact-analog manner depending on the glasses pose with respect to the environment coordinate system in the respective viewing angle area in which the user of the data glasses 3 looks and in which environment objects are able to be perceived. In other words, the display object indicated by the object information is displayed on the display surface 35 if its environment position is in the viewing angle area. Media content is presented in a presentation window. The presentation window is an area, preferably a rectangular area, which fills only a partial area of the display surface, and can be positioned in a manner tied to the vehicle and is then presented in a contact-analog manner at a certain position in the vehicle. Alternatively, the presentation window can also be firmly positioned on the display surface of the data glasses.

The user N of the data glasses 3 is located as an occupant in the vehicle 1, and the glasses pose of the data glasses 3 can change by virtue of head movements and a movement of the vehicle. This glasses pose is determined continuously and in real time in a manner known per se using the sensor system described above. For the contact-analog presentation of a display object based on an environment position, i.e. the corresponding object information is provided with an environment position, on the display surface of the data glasses 3, an absolute glasses pose indication based on the environment coordinate system must be available in the data glasses 3. Accordingly, for the contact-analog presentation of a display object based on a position tied to the vehicle, i.e. the corresponding object information is provided with a position relative to the vehicle, on the display surface of the data glasses 3, an absolute glasses pose indication based on the vehicle coordinate system must be available in the data glasses 3.

According to a user operation, the data glasses 3 now receive, from the assistance system 2, information about display objects, such as media contents, which are to be displayed in a presentation window to be displayed with respect to a position tied to the vehicle. The position and orientation of the presentation window can be freely selected with respect to its position by the user N of the data glasses 3 and is usually selected in the viewing direction of a presentation surface.

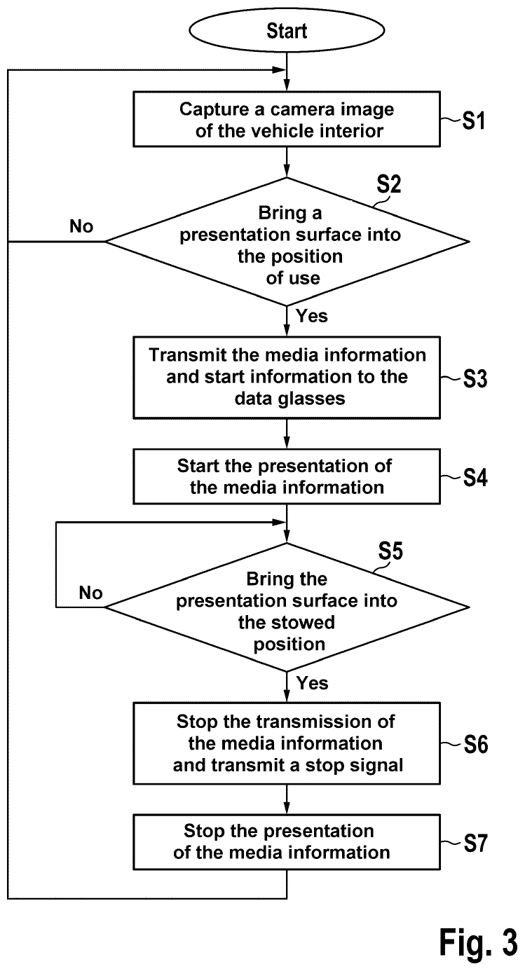

In FIG. 3, a method for operating the display system with the data glasses is described in more detail by means of a flowchart.

In step S1, an image of the vehicle interior is recorded with the aid of the interior camera 21 and a movement of a user N of the data glasses 3 is monitored. This is effected using vision tracking methods in which a movement or gesture of the arms of the user, especially the user wearing the data glasses 3, is observed.

In step S2, it is checked whether an operation or gesture of the user, in the case of which a presentation surface is brought from a stowed position into a position of use, has been recognized. Such a presentation surface may be provided, for example, on a rear side of a sun visor 11 or in the form of a surface that can be folded out on, for example, the top side of an instrument panel. The monitored movement or gesture of the arms of the user N of the data glasses 3 then corresponds to an extension of the arm with a corresponding movement which can correspond to a folding down of the presentation surface into the position of use or the like. If a corresponding movement of the arms of the user is recognized (alternative: yes), in step S3, media information, i.e. image or video information, is transmitted to the data glasses 3 as object information and start information signaling the start of the presentation of the media information in the data glasses 3 is transmitted at the same time. In the case of video information, the transmission takes place in the form of a data stream (streaming). Otherwise (alternative: no), the process jumps back to step S1.

The media information is now presented in the data glasses in step S4 after receiving the start information. After bringing the presentation surface into the position of use, the media information is thus played back automatically, and the user only has to direct their viewing direction to the presentation surface in order to be able to view the media information without disturbing background perception.

In step S5, it is checked whether an operation or gesture of the user, in the case of which a presentation surface is brought from the position of use into a stowed position, has been recognized. The monitored movement or gesture of the arms of the user N of the data glasses 3 then corresponds to an extension of the arm with a corresponding movement which can correspond to a folding of the presentation surface into the stowed position or the like.

If a corresponding movement of the arms of the user is recognized (alternative: yes), in step S6, the transmission of the object information of the media information to the data glasses 3 is stopped and stop information signaling the stop of the presentation of the media information in the data glasses 3 is transmitted at the same time. In the case of video information, the transmission takes place in the form of a data stream (streaming). Otherwise, the process jumps back to step S1.

The output of the media information is now stopped in step S7 in the data glasses 3 after receiving the stop information. Once the presentation surface has been brought into the stowed position, the playback of the media information is thus stopped automatically.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

1 Vehicle
11 Sun visor
2 Assistance system
3 Data glasses
4 Communication connection
21 Interior camera
23 Communication unit
24 Control unit
25 Vehicle motion sensor system (IMU sensor system)
31 Frame
32 Lenses
33 Glasses temples
35 Display surface
36 Display device
37 Control unit
38 Glasses motion sensor system
39 Communication device

What is claimed is:

1. A method for operating a display system with an assistance system tied to the vehicle and data glasses in a vehicle, the method comprising:
monitoring whether a presentation surface has been brought from a stowed position into a position of use in which the presentation surface faces the data glasses, wherein the presentation surface is a dark or black, in particular unstructured surface;
transmitting start information from the assistance system to the data glasses in response to recognizing that the presentation surface has been brought into the position of use; and
automatically starting and displaying media information in the data glasses depending on the start information.

2. The method of claim 1, further comprising:
monitoring whether the presentation surface has been brought into a stowed position in which the presentation surface is stowed;
transmitting stop information from the assistance system to the data glasses, in response to recognizing that the presentation surface has been brought into the stowed position; and
automatically stopping the display of the media information in the data glasses depending on the stop information.

3. The method of claim 1, wherein the process of monitoring whether the presentation surface has been brought into the position of use or into the stowed position is carried out by evaluating a camera image from an interior camera with gesture recognition, wherein the position of use or the stowed position is adopted by recognizing a particular gesture in each case.

4. The method of claim 1, wherein, if it is recognized that the presentation surface has been brought into the position of use, in addition to the start information, the media information to be presented is also transmitted from the assistance system to the data glasses.

5. The method of claim 1, wherein the presentation surface is located on a rear side of a foldable sun visor.

6. The method of claim 1, wherein the media information is displayed in a contact-analog manner with respect to a coordinate system tied to the vehicle on or in front of the presentation surface.

7. An apparatus for operating a display system with data glasses in a vehicle, comprising:
a control unit configured to monitor whether a presentation surface has been brought from a stowed position into a position of use in which the presentation surface faces the data glasses, wherein the presentation surface is a dark or black, in particular unstructured surface; and
a communication unit configured to transmit start information from the assistance system to the data glasses, if it is recognized that the presentation surface has been brought into the position of use.
